(19) United States
(12) Patent Application Publication
(10) Pub. No.: US 2017/0361583 A1
(43) Pub. Date: Dec. 21, 2017

(54) FILM WITH IMPROVED FLEX CRACK RESISTANCE

(71) Applicant: ENTEGRiS, INC., Billerica, MA (US)

(72) Inventors: Brenna BROSCH, Billerica, MA (US); Amy KOLAND, Billerica, MA (US)

(21) Appl. No.: 15/533,721

(22) PCT Filed: Dec. 1, 2015
(86) PCT No.: PCT/US2015/063185

§ 371 Date: Jun. 7, 2017

Related U.S. Application Data
(60) Provisional application No. 62/089,071, filed on Dec. 8, 2014.
(60) Provisional application No. 62/089,075, filed on Dec. 8, 2014.

(51) Int. Cl. B32B 27/08; B29C 47/00; B65D 23/02; B29C 47/06; B32B 27/34; B65D 25/14; B32B 27/30; B29K 77/00; B29K 23/00; B29L 23/00; B29L 9/00

(52) U.S. Cl. CPC B32B 27/08; B65D 25/14; B29C 47/0026; B65D 23/02; B29C 47/065; B32B 27/306; B32B 27/34; B29K 2023/086; B29L 2023/001; B29L 2009/00; B29K 2995/0081; B32B 2439/46; B29K 2077/00; B32B 2307/5825; B32B 2307/7242; B29K 2995/0067

(57) ABSTRACT

Provided herein are liners, for example, for storing or dispensing high purity chemicals, as well as methods of manufacturing such liners. The liners resist formation of stress-induced breaches. In one aspect, the liner includes a film formed into a liner capable of retaining a liquid. The liner has a first barrier layer to a gas (e.g., oxygen); a second barrier layer to the gas (e.g., oxygen); and at least one additional layer of material disposed interstitially between the first barrier layer and the second barrier layers.

### RELATED APPLICATIONS

This application claims the benefit of U.S. Provisional Application Nos. 62/089,075 and 62/089,071, filed on Dec. 8, 2014. The entire teachings of these applications are incorporated herein by reference for any purpose.

### BACKGROUND OF THE INVENTION

Liner-based containers are utilized in the transport and dispensing of liquid chemicals. Such liner-based containers include so-called bag-in-can (BIC) containers, bag-in-bottle (BIB) containers, and bag-in-drum (BID) containers. During transportation, a liquid-filled liner can develop flex cracks due to repetitive stresses associated with shock and vibration of the container that are transferred to the liquid-filled liner. The flex cracks can lead to permeation of gas through the liner, as well as the leaking of liquid through the liner wall.

A liner-based system that resists formation of flex cracks during transport of liquid would be welcomed.

### SUMMARY OF THE INVENTION

The present disclosure is related to liners (e.g., liners for storing or dispensing high purity chemicals) that resist formation of stress-induced breaches, as well as methods of manufacturing such liners. In one aspect, the liner comprises a film formed into a liner capable of retaining a liquid. The film comprises a first barrier layer to a gas (e.g., oxygen); a second barrier layer to the gas (e.g., oxygen); and at least one additional layer of material disposed interstitially between the first barrier layer and the second barrier layer.

Various embodiments of the disclosure provide liners having multiple (i.e., at least two) barrier layers having low permeability to a gas, such as oxygen. In some embodiments, the combined thickness of the barrier layers is thick enough to provide a needed level of protection against permeation of the gas, yet individually thin enough to enable the barrier layers to flex without imparting undue stress on the individual barrier layer. In other embodiments, each barrier layer is thick enough to provide the needed level of protection against permeation of the specified gas, and still thin enough to survive the rigors of transport without developing flex cracks.

In various embodiments, the barrier layers are separated by a thickness of interstitial material or materials so that development of a flex crack in one layer is not in alignment with flex cracks that may develop in other layer(s). Thus, even where flex cracks develop in one or more barrier layers, there is no direct through passage through the liner wall, thereby mitigating liner leaking.

Also provided herein is a liner having a film comprising an interface, a first innermost layer, a second innermost layer, a first interstitial layer, a second interstitial layer, a first barrier layer, a second barrier layer, a third interstitial layer, a fourth interstitial layer, a first cladding layer and a second cladding layer. The first and second innermost layers contact one another to define the interface. The first interstitial layer is disposed between the first innermost layer and the first barrier layer and the first barrier layer is disposed between the first interstitial layer and the third interstitial layer. The first cladding layer is disposed on the exterior of the third interstitial layer. The second interstitial layer is disposed between the second innermost layer and the second barrier layer and the second barrier layer is disposed between the second interstitial layer and the fourth interstitial layer. The second cladding layer is disposed on the exterior of the fourth interstitial layer.

Also provided herein is a method of manufacturing a liner (e.g., a two-dimensional (2-D) liner, a three-dimensional (3-D) liner) that resists formation of stress-induced breaches. The method comprises co-extruding a tubular structure including a wall having a plurality of layers, including an innermost layer and a barrier layer surrounding the innermost layer. The barrier layer provides a barrier to a gas. The tubular structure is collapsed so that the innermost layer contacts itself at an interface to define a sheet material having a mirror image of the plurality of layers about the interface and providing two innermost layers captured between two barrier layers. The sheet material is formed into a liner capable of retaining a liquid.

The multiple barrier layers of the films of the present disclosure demonstrated a higher resistance to stress-induced breaches than conventional films having a single barrier layer of similar overall thickness and gas permeability to the multiple barrier layers of the present disclosure. Based on testing utilizing the ASTM F392 protocol, development of through holes in liners of the present disclosure is up to three times less than for liners utilizing conventional films having a single barrier layer. Surprisingly, this result occurs even though the cumulative thickness of the barrier layers of the present disclosure is substantially the same as the thickness of the single barrier layer of the conventional film.

The preceding summary is provided to facilitate an understanding of some of the innovative features unique to the present disclosure and is not intended to be a full description. A full appreciation of the disclosure can be gained by taking the entire specification, claims, drawings and abstract as a whole.

### BRIEF DESCRIPTION OF THE DRAWINGS

The disclosure may be more completely understood in consideration of the following description of various illustrative embodiments in connection with the accompanying drawings.

FIG. 1 is a sectional view of a film in an embodiment of the disclosure.

FIG. 2 is a schematic sectional view of a film fabricated by a collapsed bubble technique in an embodiment of the disclosure.

FIG. 3 is a schematic sectional view of a film fabricated by a collapsed bubble technique in an embodiment of the disclosure.

FIG. 4 is a schematic sectional view of a film fabricated by a collapsed bubble technique in an embodiment of the disclosure.

FIG. 5A is a side elevational view of a two-dimensional (2-D) liner in an embodiment of the disclosure.

FIG. 5B is a perspective view of a three-dimensional (3-D) liner in an embodiment of the disclosure.

FIG. 6A is a graph of test results comparing polyamide-containing liners of the present disclosure with a liner utilizing a conventional polyamide film.

FIG. 6B is a graph of test results comparing ethylene vinyl alcohol (EVOH)-containing liners of the present disclosure of varying thicknesses with a liner utilizing a conventional polyamide film.

FIG. 7 is a graph comparing the failure rates of various 200 L liners of the present disclosure and 200 L comparative liners as a function of transportation time.

While the disclosure is amenable to various modifications and alternative forms, specifics thereof have been shown by way of example in the drawings and will be described in detail. It should be understood, however, that the intention is not to limit aspects of the disclosure to the particular illustrative embodiments described. On the contrary, the intention is to cover all modifications, equivalents, and alternatives falling within the spirit and scope of the disclosure.

### DETAILED DESCRIPTION OF THE INVENTION

The following detailed description should be read with reference to the drawings in which similar elements in different drawings are numbered the same. The detailed description and the drawings, which are not necessarily to scale, depict illustrative embodiments and are not intended to limit the scope of the invention. The illustrative embodiments depicted are intended only as exemplary. Selected features of any illustrative embodiment may be incorporated into an additional embodiment unless clearly stated to the contrary.

While various compositions and methods are described, it is to be understood that this invention is not limited to the particular compositions, designs, methodologies or protocols described, as these may vary. It is also to be understood that the terminology used in the description is for the purpose of describing the particular versions or embodiments only, and is not intended to limit the scope of the present invention which will be limited only by the appended claims.

As used in this specification and the appended claims, the singular forms “a”, “an” and “the” include plural referents unless the content clearly dictates otherwise.

Unless defined otherwise, all technical and scientific terms used herein have the same meanings as commonly understood by one of ordinary skill in the art. Methods and materials similar or equivalent to those described herein can be used in the practice or testing of embodiments of the present invention. All publications mentioned herein are incorporated by reference in their entirety. Nothing herein is to be construed as an admission that the invention is not entitled to antedate such disclosure by virtue of prior invention. “Optional” or “optionally” means that the subsequently described event or circumstance may or may not occur, and that the description includes instances where the event occurs and instances where it does not. All numeric values herein can be modified by the term “about,” whether or not explicitly indicated. The term “about” generally refers to a range of numbers that one of skill in the art would consider equivalent to the recited value (i.e., having the same function or result). In some embodiments the term “about” refers to ±10% of the stated value; in other embodiments the term “about” refers to ±2% of the stated value. While compositions and methods are described in terms of “comprising” various components or steps (interpreted as meaning “including, but not limited to”), the compositions and methods can also “consist essentially of” or “consist of” the various components and steps, which terminology should be interpreted as defining essentially closed or closed member groups.

One aspect of the present disclosure is a liner (e.g., for storing or dispensing high purity chemicals) that resists formation of stress-induced breaches. The liner comprises a film formed into a liner capable of retaining a liquid. The film comprises a first barrier layer to a gas (e.g., oxygen); a second barrier layer to the gas (e.g., oxygen); and at least one additional layer of material disposed interstitially between the first barrier layer and the second barrier layer.

Typically, the liners described herein are sealed or closeable liners, such that the liner provides a barrier between the interior volume defined by the liner and the environment. Sealed or closeable liners are suitable for maintaining the purity of chemicals or other contents (e.g., high purity chemicals, inert materials, semiconductor liquids) to be contained therein. The liner can comprise 1, 2, 3, 4, or 5 plies of film. In a specific embodiment, the liner comprises a single ply of film.

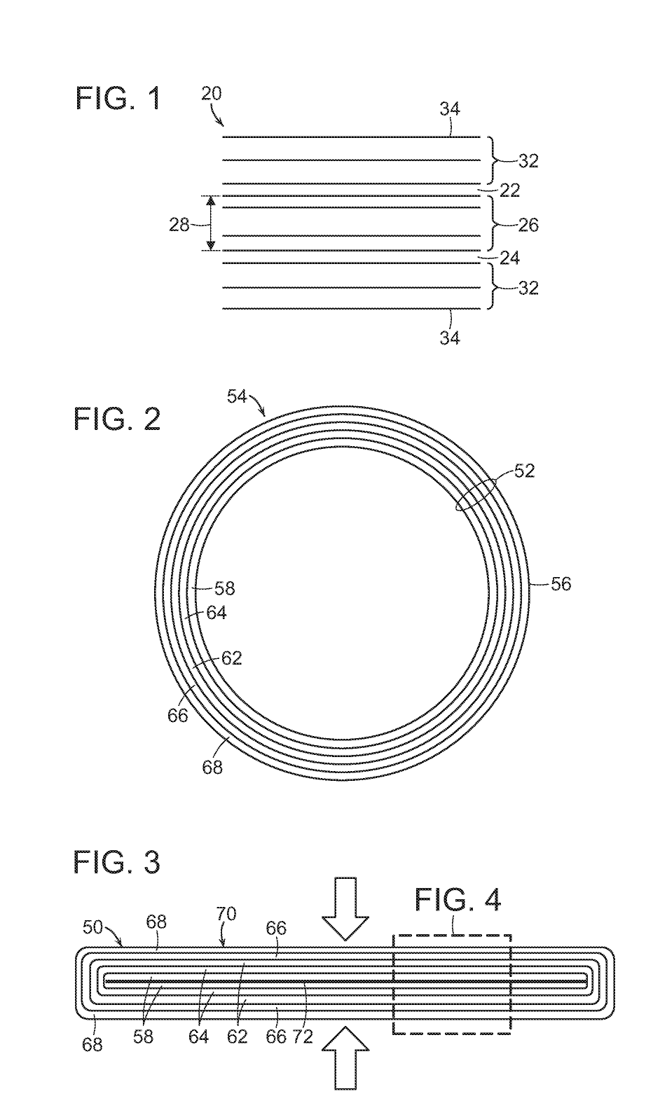

A film 20 for resisting formation of through holes is depicted in FIG. 1. As used herein, “through holes” refers to a breach in a film formed by pinholes or flex cracks that traverse the thickness of the film or by the alignment or substantial alignment of pinholes or flex cracks in one or more layers of film with pinholes or flex cracks in one or more other layers of the film.

Film 20 includes first barrier layer 22 and second barrier layer 24 separated by one or more additional layers 26 of material disposed interstitially between first and second barrier layers 22 and 24, thereby separating barrier layers 22 and 24 by distance 28 substantially equal to the thickness of layer(s) 26. In various embodiments, one or more cladding layers 32 can be deposited on opposing sides of film 20 to define outer surfaces 34 of film 20. In one embodiment, barrier layers 22 and 24 are of substantially equal thickness.

Barrier layers 22 and 24 can be chosen to provide a desired permeability for a gas, such as oxygen, nitrogen, or carbon dioxide. In some cases, barrier layers 22 and 24 can be selected to provide a desired permeability for oxygen. Herein, permeability is expressed in units of cubic centimeters mil per 100 in² per day (cc-mil/100 in²/day), which is normalized to the thickness of the material. Units of cc-mil/100 in²/day can be converted into units of cm³-mm/m²/day/atm by multiplying by 0.3937. The level of permeability for a given gas is a function of the material. As used herein, a “moderate” gas permeability falls in the range of from 1 cc-mil/100 in²/day (0.4 cm³-mm/m²/day/atm) to about 10 cc-mil/100 in²/day (3.9 cm³-mm/m²/day/atm), and a “low” gas permeability is less than 1 cc-mil/100 in²/day (0.4 cm³-mm/m²/day/atm) and greater than or equal to about 0.1 cc-mil/100 in²/day (0.04 cm³-mm/m²/day/atm). For example, nylons typically have oxygen permeation rates of from about 2 cc-mil/100 in²/day (0.8 cm³-mm/m²/day/atm) to about 4 cc-mil/100 in²/day (1.6 cm³-mm/m²/day/atm), and are said to have a “moderate” oxygen permeability or to serve as a “moderate” oxygen barrier. Nylon 6 has an oxygen permeation rate of about 3.5 cc-mil/100 in²/day (0.20 cm³-mm/m²/day/atm) at 0% relative humidity and 23° C. Nylon 6/66 has an oxygen permeation rate of from about 2.2 cc-mil/100/in²/day (0.87 cm³-mm/m²/day/atm) to about 2.6 cc-mil/100/in²/day (1.0 cm³-mm/m²/day/atm) at 0% relative humidity and 23° C. Ethylene vinyl alcohol (EVOH), on the other hand, has an oxygen permeation rate of about 0.06 cc-mil/100 in²/day (0.02 cm³-mm/m²/day/atm) at 0% relative humidity and 23° C., and thus is said to have a “low” oxygen permeability or to serve as a “high” oxygen barrier. While the foregoing gas permeability values are specific to oxygen, permeability data for these and other materials are available to the artisan for various gases, including nitrogen and carbon dioxide. See, for example, McKeen, L. W., Permeability Properties of Plastics and Elastomers, 3d Edition, Elsevier, Inc. (2012).

In some embodiments of the present disclosure, the first barrier layer and the second barrier layer of the liner each independently have a gas permeability for a gas of from about 0.05 to about 10 cc-mil/100 in²/day, from about 0.1 to about 10 cc-mil/100 in²/day, from about 1 to about 10 cc-mil/100 in²/day, from about 0.05 to about 1 cc-mil/100 in²/day or from about 0.1 to about 1 cc-mil/100 in²/day for the gas. For example, the gas permeability of the first barrier layer can be from about 1 to about 10 cc-mil/100 in²/day and the gas permeability of the second barrier layer can be from about 0.1 to about 1 cc-mil/100 in²/day for the gas.

In some embodiments, the first barrier layer and the second barrier layer of the liner each have the same or substantially the same gas permeability for a gas. For example, the first and second barrier layers can each have a gas permeability for a gas of from about 0.05 to about 10 cc-mil/100 in²/day, from about 0.1 to about 10 cc-mil/100 in²/day, from about 1 to about 10 cc-mil/100 in²/day, from about 0.05 to about 1 cc-mil/100 in²/day or from about 0.1 to about 1 cc-mil/100 in²/day for the gas.

Materials suitable for barrier layers 22 and 24 and having a moderate oxygen permeability include, but are not limited to, polyamide, polyethylene terephthalate (PET), amorphous polyethylene terephthalate (APET), polyethylene terephthalate glycol-modified (PETG) and polyethylene naphthalate (PEN). Materials suitable for barrier layers 22 and 24 and having a low oxygen permeability include, but are not limited to, polychlorotrifluoroethene (PCTFE or PTFCE), cyclic olefin copolymer (COC), liquid crystal polymer (LCP), EVOH and polyvinylidene chloride (PVDC).

In some embodiments of the present disclosure, the first barrier layer and the second barrier layer are the same material. For example, in some aspects, the material of the first barrier layer and the second barrier layer comprises polyamide. In other embodiments, the material of the first barrier layer and the second barrier layer includes EVOH.

Functionally, the separation of the first and second barrier layers 22 and 24 provides two distinct barriers to permeation of a gas or leaking of a liquid. Permeation of a gas can affect the quality of a liquid contained in the liner while liquid leaks are a sign of gross failure of the liner. Because the development of flex cracks can be somewhat random for a given barrier layer, there is a substantial probability that a flex crack that develops in first barrier layer 22 will be offset from (i.e., not in substantial alignment with) any flex cracks that develop in second barrier layer 24. In such circumstance, the gas or liquid would have to work its way through a tortuous path between the offset (unaligned) flex cracks. That is, most or all of the flex cracks that may develop in first barrier layer 22 do not align directly with most or all of the flex cracks that may develop in second barrier layer 24, so that there are few, if any, through holes defined through first and second barrier layers 22 and 24. Accordingly, even though flex cracks may develop in one or both of the barrier layers 22 and/or 24, the integrity of film 20 can be maintained.

Furthermore, because barrier layers 22 and 24 are separated by layers 26, each can be of substantially less thickness than that of a single barrier layer while in combination providing equal barrier resistance. The reduced thickness provides for reduced stress on barrier layers 22 and 24 during the rigors of transport, leading to the development of fewer through holes.

The foregoing embodiment is directed to film 20 having two barrier layers 22 and 24. Embodiments having three or more barrier layers (e.g., three, four or five) are also contemplated and can be readily implemented by the skilled artisan in view of the concepts disclosed herein. Characteristics of additional barrier layers (e.g., thickness, material, gas permeability) are as described herein with respect to the first and second barrier layers.

Referring to FIGS. 2 through 4, implementation of film structure 50 fabricated from a “collapsed bubble” technique is schematically depicted in an embodiment of the disclosure. The collapsed bubble technique is described, for example, in U.S. Pat. No. 6,921,608 to Call et al., the disclosure of which is incorporated by reference herein in its entirety except for express definitions and patent claims contained therein.

Initially, a plurality of layers 52 are coextruded through an annular die (not depicted) to define tubular structure 54 having wall 56 (FIG. 2). Wall 56 includes innermost layer 58 and barrier layer 62 surrounding innermost layer 58. The coextruded layers of wall 56 can further include one or more interstitial layers 64 disposed between barrier layer 62 and innermost layer 58. In various embodiments, second interstitial layer 66 can be disposed on the exterior of barrier layer 62 and cladding layer 68 can be disposed on the exterior of second interstitial layer 66.

In some embodiments of the present disclosure, the film (e.g., film 20, film structure 50) has a thickness of from about 25 μm to about 500 μm, from about 50 μm to about 250 μm, from about 75 μm to about 200 μm, from about 100 μm to about 150 μm, or from about 100 μm to about 130 μm.

In some embodiments, the melting temperature of innermost layer 58 is lower than the melting temperature of the remaining layers (e.g., interstitial layers 64 and 66, barrier layer 62, cladding layer 68) such that innermost layer 58 can be selectively sealed to itself. For example, innermost layer 58 may remain tacky at temperatures at which other layers are solid. Thus, in various embodiments, innermost layer 58 is selected to adhere to itself upon contact. In other embodiments, an adhesive (not depicted) can be disposed on innermost layer 58 to provide adhesion.

Exemplary materials for innermost layer 58 include plastomers, such as polyethylene (e.g., metallocene polyethylene (mPE), linear low density polyethylene (LLDPE)) and ethyl vinyl acetate, or a blend of the foregoing. In some embodiments, innermost layer 58 is a mPE/LLDPE blend. The thickness of innermost layer 58 can be from about 3% to about 70%, from about 5% to about 30%, or from about 20% to about 40% of the total thickness of film structure 50. Innermost layer 58 can have a thickness of from about 1 μm to about 350 μm, from about 1 μm to about 150 μm, from about 5 μm to about 200 μm or from about 10 μm to about 30 μm.

Interstitial layers 64 and 66 function as tie layers, facilitating the bonding of dissimilar materials, such as polyamides or EVOH and mPE/LLDPE, to one another. Exemplary materials for interstitial layers 64 and 66 include, but are not limited to, polyethylene (e.g., maleic anhydride-modified PE, low-density polyethylene (LDPE), mPE, LLDPE) or a blend thereof. In a particular embodiment, interstitial layers 64 and 66 each comprise a layer of PE/LDPE, such as a maleic anhydride-modified PE/LDPE blend, and a layer of mPE/LLDPE. Interstitial layers 64 and 66 can also be of different compositions. The thickness of interstitial layers 64 and 66 can each independently be from about 2% to about 70%, from about 3% to about 15% or from about 10% to about 25% of the total thickness of film structure 50. Interstitial layers 64 and 66 can each independently have a thickness of from about 0.5 μm to about 350 μm, from about 0.75 μm to about 75 μm, from about 2.5 μm to about 100 μm or from about 5 μm to about 20 μm.

The thickness of barrier layer 62 can be from about 2% to about 50%, from about 3% to about 15% or from about 5% to about 10% of the total thickness of film structure 50. Thus, in some embodiments of the present disclosure, barrier layer 62 has a thickness of from about 0.5 μm to about 250 μm, from about 0.75 μm to about 75 μm, from about 1 μm to about 50 μm or from about 1 μm to about 10 μm. In some aspects of the present disclosure, the first barrier layer and the second barrier layer are of substantially the same or the same thickness and each have a thickness of from about 1 μm to about 25 μm, from about 2.5 μm to about 10 μm or about 5 μm.

Cladding layer 68 is typically selected to be chemically compatible with the intended liquid to be stored in or dispensed from a liner described herein. For example, linear low-density polyethylene (LLDPE) has been shown to be chemically compatible with photoresists. Fluoropolymers have been shown to chemically compatible with liquids typically used in the semiconductor industry. Exemplary materials for cladding layer 68 include LLDPE and fluoropolymers, or a blend thereof. In a particular embodiment, cladding layer 68 comprises LLDPE. The thickness of cladding layer 68 can be from about 3% to about 70%, from about 10% to about 30% or from about 15% to 30% of the total thickness of film structure 50. Cladding layer 68 can have a thickness of from about 1 μm to about 350 μm, from about 2.5 μm to about 150 μm, from about 5 μm to about 150 μm or from about 5 μm to about 25 μm.

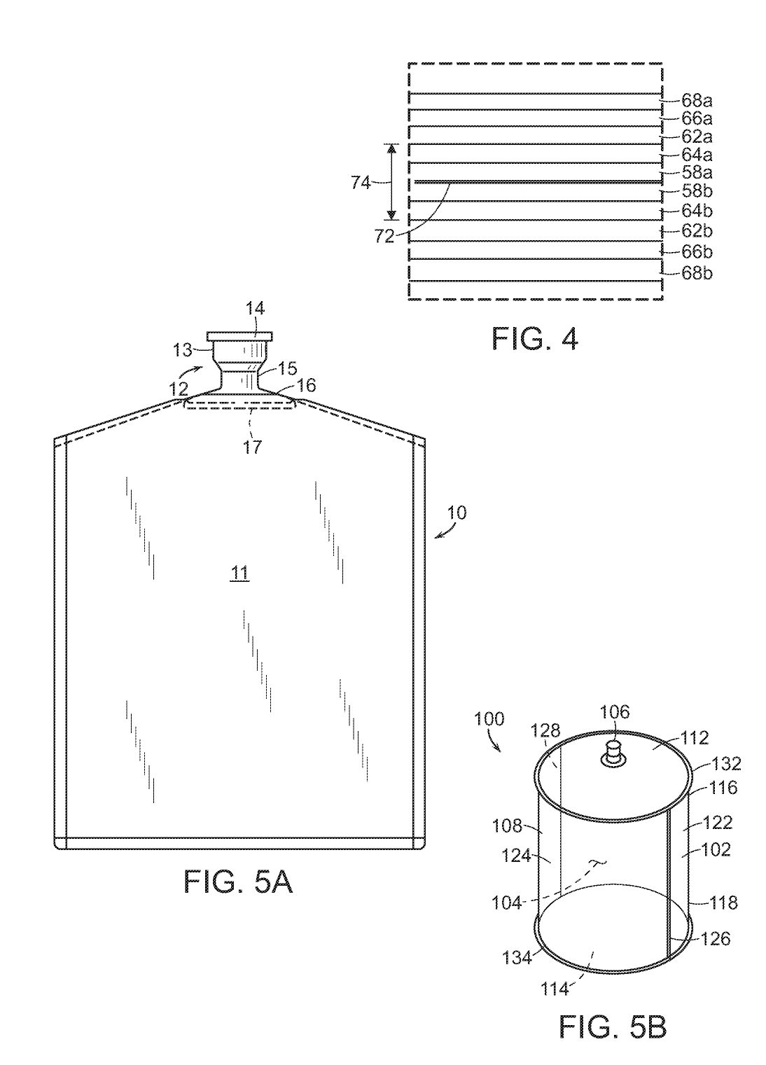

After formation, tubular structure 54 is collapsed upon itself to define film sheet 70 (FIG. 3). Innermost layer 58 contacts itself to define interface 72 (also referred to in the art as a block layer). By this technique, a sectional view of film sheet 70 defines a mirror image about interface 72, so that there are dual layers for every layer defined in tubular structure 52. The dual layers are identified in FIG. 4 by suffix “a” and “b” designation. As such, in the embodiment depicted in FIG. 4, the collapsed bubble technique provides two barrier layers 62a and 62b separated by combined thickness 74 of innermost layers 58a, 58b and interstitial layers 64a, 64b. Outer cladding layers 68a and 68b are disposed on the exterior of interstitial layers 66a, 66b, which are disposed, in turn, on the exterior of barrier layers 62a and 62b. Barrier layers 62a and 62b, being separated by combined thickness 74, operate in accordance with the principles described attendant to FIG. 1 above.

Also, tubular structure 52 can comprise more than one barrier layer, to define a plurality of barrier layers that is a multiple of two. That is, if the tubular structure includes two barrier layers, there will be four barrier layers in the collapsed sheet structure; if the tubular structure includes three barrier layers, there will be six barrier layers in the collapsed sheet structure; and so on.

Also provided herein is a method of manufacturing a liner (e.g., a 2-D liner, a 3-D liner) that resists formation of stress-induced breaches. The method comprises co-extruding a tubular structure including a wall having a plurality of layers, including an innermost layer and a barrier layer surrounding the innermost layer. The barrier layer provides a barrier to a gas. The tubular structure is collapsed so that the innermost layer contacts itself at an interface to define a sheet material having a mirror image of the plurality of layers about the interface and providing two innermost layers captured between two barrier layers. The sheet material is formed into a liner capable of retaining a liquid. In some aspects of this embodiment, the tubular structure comprises at least one interstitial layer between the innermost layer and the barrier layer, such that the sheet material provides two interstitial layers disposed between the two barrier layers after the step of collapsing. In some aspects of this embodiment, the innermost layer bonds to itself at the interface after the step of collapsing.

One embodiment of the present disclosure is a liner having a film (e.g., a film formed into a liner capable of retaining a liquid) comprising an interface, a first innermost layer, a second innermost layer, a first interstitial layer, a second interstitial layer, a first barrier layer, a second barrier layer, a third interstitial layer, a fourth interstitial layer, a first cladding layer and a second cladding layer. The first and second innermost layers contact one another to define the interface. The first interstitial layer is disposed between the first innermost layer and the first barrier layer and the first barrier layer is disposed between the first interstitial layer and the third interstitial layer. The first cladding layer is disposed on the exterior of the third interstitial layer. The second interstitial layer is disposed between the second innermost layer and the second barrier layer and the second barrier layer is disposed between the second interstitial layer and the fourth interstitial layer. The second cladding layer is disposed on the exterior of the fourth interstitial layer. Characteristics (e.g., thickness, material, gas permeability) of the cladding layers, barrier layers, interstitial layers and innermost layers are each independently as described herein.

In various embodiments, the interface is formed when the first innermost layer and the second innermost layer seal to one another upon contact. In other embodiments, the interface is formed by an adhesive disposed between the first and second innermost layers. In embodiments in which the interface is formed by an adhesive, the first or second innermost layer or the first and second innermost layers comprise an adhesive on the surface or portion of the surface of the innermost layer that contacts the other innermost layer.

In some embodiments, the first innermost layer and the second innermost layers are the same; the first interstitial layer and the second interstitial layer are the same; the first barrier layer and the second barrier layer are the same; the third interstitial layer and the fourth interstitial layer are the same; and the first cladding layer and the second cladding layer are the same, as in a collapsed bubble film, for example. In such embodiments, the film is typically symmetrical about the interface. In a particular embodiment of a liner comprising a film symmetrical about the interface, the first and second innermost layers are a mPE/LLDPE blend (e.g., mPE/LLDPE about 80/about 20); the first and second barrier layers are polyamide (e.g., nylon 6/66); and the first and second cladding layers are LLDPE. In another particular embodiment of a liner comprising a film symmetrical about the interface, the first and second innermost layers are a mPE/LLDPE blend (e.g., mPE/LLDPE about 80/about 20); the first and second interstitial layers are a maleic anhydride-modified PE/LDPE blend; the first and second barrier layers are polyamide (e.g., nylon 6/66); the third and fourth interstitial layers each comprise a layer of mPE/LLDPE disposed on the exterior of a layer of maleic acid anhydride-modified PE/LDPE; and the first and second cladding layers are LLDPE. In yet another particular embodiment of a liner comprising a film symmetrical about the interface, the first and second innermost layers are a mPE/LLDPE blend (e.g., mPE/LLDPE about 80/about 20); the first and second barrier layers are EVOH; and the first and second cladding layers are LLDPE. In yet another particular embodiment of a liner comprising a film symmetrical about the interface, the first and second innermost layers are a mPE/LLDPE blend (e.g., mPE/LLDPE about 80/about 20); the first and second interstitial layers each comprise a layer of maleic anhydride-modified PE/LDPE disposed on the exterior of a layer of mPE/LLDPE; the first and second barrier layers are EVOH; the third and fourth interstitial layers each comprise a layer of mPE/LLDPE disposed on the exterior of a layer of maleic acid anhydride-modified PE/LDPE; and the first and second cladding layers are LLDPE.

Another embodiment of the present disclosure is a liner including a collapsed bubble film (e.g., a film formed into a liner capable of retaining a liquid) symmetrical about an interface. The film comprises an innermost layer, a first interstitial layer, a barrier layer, a second interstitial layer and a cladding layer. The first interstitial layer is disposed between the innermost layer and the barrier layer and the barrier layer is disposed between the first interstitial layer and the second interstitial layer. The cladding layer is disposed on the exterior of the second interstitial layer. Characteristics (e.g., thickness, material, gas permeability) of the cladding layers, barrier layers, interstitial layers and innermost layers are each independently as described herein.

In some embodiments of a liner comprising a collapsed bubble film symmetrical about an interface, the innermost layer is a mPE/LLDPE blend (e.g., mPE/LLDPE about 80/about 20), the barrier layer is polyamide (e.g., nylon 6/66) or EVOH and the cladding layer is LLDPE. In an aspect of these embodiments, the first and second interstitial layers each comprise a layer of maleic anhydride-modified PE/LDPE and a layer of mPE/LLDPE.

Table 1 discloses a polyamide-containing film structure formed from a collapsed bubble technique and symmetrical about an interface. Table 1 lists the layer in the left column, percentage of the thickness of that layer in the middle column and a reference thickness for a 125 μm-thick film in the right column. The film structure disclosed in Table 1 includes two barrier layers of polyamide (nylon 6/66), each being 4% of the total thickness, or 5 μm. The barrier layers are separated by two innermost layers (PE/octane), two interstitial layers (PE/LDPE blend) and two tie layers that total 52% of the total thickness of the film, or 65 μm.

TABLE 1

| | | REF: THICKNESS |
|---|---|---|
| LAYER | PERCENTAGE | (MICRON) |
| LLDPE | 11 | 13.8 |
| mPE/LDPE (80/20 BLEND) | 3.5 | 4.4 |
| TIE (BLEND) | 5.5 | 6.9 |
| NYLON 6/66 | 4 | 5.0 |
| TIE (BLEND) | 5.5 | 6.9 |
| mPE/LDPE BLEND | 5.5 | 6.9 |
| mPE/LLDPE (80/20 BLEND) | 15 | 18.8 |
| mPE/LLDPE (80/20 BLEND) | 15 | 18.8 |
| mPE/LDPE BLEND | 5.5 | 6.9 |
| TIE (BLEND) | 5.5 | 6.9 |
| NYLON 6/66 | 4 | 5.0 |
| TIE (BLEND) | 5.5 | 6.9 |
| mPE/LDPE (80/20 BLEND) | 3.5 | 4.4 |
| LLDPE | 11 | 13.8 |

Table 2 discloses an EVOH-containing film structure of the present disclosure formed from a collapsed bubble technique and symmetrical about an interface. Table 2 lists the layer in the left column, percentage of the thickness of that layer in the middle column and a reference thickness for a 125 μm-thick film in the right column. The film structure disclosed in Table 2 includes two barrier layers of EVOH, each being 4% of the total thickness, or 5 μm. The barrier layers are separated by two innermost layers (PE/octane), two interstitial layers (PE/LDPE blend) and two tie layers that total 52% of the total thickness of the film, or 65 μm.

TABLE 2

| | | REF: THICKNESS |
|---|---|---|
| LAYER | PERCENTAGE | (MICRON) |
| LLDPE | 11 | 13.8 |
| mPE/LDPE (80/20 BLEND) | 3.5 | 4.4 |
| TIE (BLEND) | 5.5 | 6.9 |
| EVOH | 4 | 5.0 |
| TIE (BLEND) | 5.5 | 6.9 |
| mPE/LDPE BLEND | 5.5 | 6.9 |
| mPE/LLDPE (80/20 BLEND) | 15 | 18.8 |
| mPE/LLDPE (80/20 BLEND) | 15 | 18.8 |
| mPE/LDPE BLEND | 5.5 | 6.9 |
| TIE (BLEND) | 5.5 | 6.9 |
| EVOH | 4 | 5.0 |
| TIE (BLEND) | 5.5 | 6.9 |
| mPE/LDPE (80/20 BLEND) | 3.5 | 4.4 |
| LLDPE | 11 | 13.8 |

In some embodiments, the liner is a two-dimensional (2-D) or pillow-type liner (e.g., a liner comprising one ply of film, a liner comprising 2 plies of film). A 2-D liner can be formed by folding one or more sheets of a collapsed bubble film substantially in half and sealing the two halves around the perimeter. Alternatively, a 2-D liner can be formed by sealing the perimeters of two (or more, for example, 3, 4, 5, 6, 7 or 8, if the liner is multi-ply) collapsed bubble film sheets to one another. 2-D liner 10 is shown in FIG. 5A and includes fitment 12, which extends through hole 16 in the top of film 11. Fitment 12 includes mouth 13 with lip 14 at its upper end, intermediate neck 15 and lower shoulder or flange 17. Flange 17 is sealed to film 11 around hole 16.

In some embodiments of the present disclosure, the liner is a three-dimensional liner (e.g., a 3-D liner comprising 1 ply of film, a 3-D liner comprising 2 plies of film). Referring to FIG. 5B, three-dimensional (3-D) liner 100 comprising collapsed bubble film structure 102 is depicted in an embodiment of the disclosure. Collapsed bubble film structure 102 defines multiple barriers to a specified gas, for example as described attendant to FIGS. 2 through 4. In the depicted embodiment, liner 100 is generally cylindrical in shape when in a contained but expanded or filled state. Liner 100 is generally a closed liner (i.e., defines interior space 104 for holding material, interior space 104 being filled through and/or dispensed from fitment 106).

Thus, in some embodiments, a liner further comprises a fitment sealed to a portion of the liner for filling or dispensing material, particularly liquid material. Methods of attaching fitments to films are well-known in the art and include, but are not limited to, heat sealing, for example, by welding.

As shown in FIG. 5B, liner 100 includes body portion 108, top portion 112, bottom portion 114 and fitment 106. Body portion 108 includes upper end 116 and lower end 118 and can be formed from two collapsed bubble sheets 122 and 124 joined together to form two seams 126 and 128. Alternatively, body portion 108 can be fabricated from a single collapsed bubble sheet (not depicted) that is joined at a single seam (not depicted). Body portion 108 can also be formed from more than two collapsed bubble sheets (not depicted). Seams 126 and 128 can be formed by any suitable technique available to the artisan, such as welding or bonding, and can be generally vertical, as depicted.

Top and bottom portions 112 and 114 are joined to upper and lower ends 116 and 118, respectively, of body portion 108 to form upper perimeter seam 132 and lower perimeter seam 134. Top and bottom portions 112 and 114, as well as body portion 108, can be sized to be conformal to the interior of a specified overpack when in an expanded or filled state within the overpack, without exerting undue stresses on liner 100. For example, top and bottom portions 112 and 114 can be circular in shape and sized to substantially match the diameter of upper and lower ends 116 and 118 of body portion 108, which would assume a generally right-cylindrical geometry when expanded within a generally right-cylindrical overpack. In other embodiments, top portion 112 can be dimensioned larger than the diameter of upper end 116 of body portion 108, thereby forming a convex outer surface that extends above upper perimeter seam 132 when liner 100 is in an expanded state within an overpack defining a dome-shaped interior, without exerting undue stress on top portion 112 due to stretching. Likewise, bottom portion 114 can be similarly sized, extending below lower perimeter seam 134 when the liner is fully expanded within an overpack defining a basin-shaped interior. Upper and lower perimeter seams 132 and 134 can be formed by any suitable technique available to the artisan, such as welding or bonding.

Other liner forms can be implemented using the collapsed bubble sheet forms described herein. Such liner forms include the 3-D liners described in International Publication No. WO 2012/078977, as well as certain liner forms described in International Publication No. WO 2013/166018. Also, the collapsed bubble sheet form can be implemented in so-called 2-D or pillow-type liners, such as those described and depicted in International Publication Nos. WO 2006/116389 and WO 2009/032771.

In some embodiments of the present disclosure, the liner (e.g., the 2-D liner, the 3-D liner) is capable of retaining from about 1 L to about 500 L, from about 10 L to about 250 L, from about 50 L to about 250 L or from about 50 L to about 200 L of a liquid. For example, the liner is capable of retaining 4 L, 10 L, 19 L, 20 L, 40 L or 200 L of a liquid.

Example uses of such liners include, but are not limited to, transporting and dispensing ultrapure chemicals and/or materials such as photoresist, bump resist, cleaning solvents, TARC/BARC (Top-Side Anti-Reflective Coating/Bottom-Side Anti-Reflective Coating), low weight ketones and/or copper chemicals for use in such industries as microelectronic manufacturing, semiconductor manufacturing, and flat panel display manufacturing, for example. Additional uses may include, but are not limited to, transporting or dispensing acids, solvents, bases, slurries, cleaning formulations, dopants, inorganics, organics, metallorganics, TEOS, and biological solutions, pharmaceuticals, and radioactive chemicals. However, such liners may further be used in other industries and for transporting and dispensing other products such as, but not limited to, paints, soft drinks, cooking oils, agrochemicals, health and oral hygiene products, and toiletry products, etc. Those skilled in the art will recognize the benefits of such liner-based systems and the process of manufacturing the liners, and therefore will recognize the suitability of the liners for use in various industries and for the transportation and dispense of various products.

Another embodiment of the present disclosure is a liner-based system, comprising an overpack and a liner described herein. Such packaging is commonly referred to as “bag-in-can” (BIC), “bag-in-bottle” (BIB) and “bag-in-drum” (BID) packaging. Packaging of this type is commercially available under the trademark NOWPAK® from Entegris, Inc. Common sizes for an overpack include 10 L, 19 L, 40 L and 200 L, but an overpack can be of any size from 1 L to 1000 L.

An overpack can be a rigid, substantially rigid, or semi-rigid overpack. In some embodiments, an overpack comprises a wall material that is substantially more rigid than the liner material. A rigid or semi-rigid overpack can be formed, for example, of a high-density polyethylene or other polymer or metal, and the liner may be provided as a pre-cleaned, sterile collapsible bag, selected to be inert to the material (e.g., liquid) to be contained in the liner. Other suitable materials for an overpack include, but are not limited to, metal, glass, wood, plastic, composites, corrugated materials or paperboard, or a combination thereof.

The overpack, in some embodiments, can be generally cylindrically-shaped with a hollow interior capable of receiving a liner of the present disclosure. In some embodiments, a liner of the present disclosure may be configured to be compatible for use with existing overpacks. That is, in some embodiments, the overpack can be an existing drum or canister used for storing or dispensing materials, including overpacks wherein the entire lid or top opens, for example, and overpacks meeting United Nations/Department of Transportation (DOT) certifications for hazardous material. The overpack can be designed to have any suitable shape or size; however, in some embodiments, the overpack has a substantially cylindrical or barrel-like shape, including any suitable circumference or height.

Typically, an overpack contains a liquid or liquid-based composition in a liner (e.g., a liner of the present disclosure) that is secured in position in the overpack by a retaining structure such as a lid or cover. Thus, the overpack can also include a closure or connecting assembly, which can include, for example, a fitment retainer, a closure, or a shipping cap. In embodiments of the present disclosure that utilize an existing or known overpack, the closure or connecting assembly that has traditionally been used with such an overpack may be used.

The liner of a liner-based system comprising a generally cylindrically shaped overpack can be generally cylindrically-shaped, such that in an expanded state, the liner substantially conforms to the shape of the interior cavity of the overpack. In a collapsed state, the liner can collapse to fit through a neck or other opening of the overpack. If the liner includes a fitment, the fitment can be configured such that when the liner is inserted into the overpack, the fitment nests inside of a fitment retainer or the neck or opening of the overpack.

A fitment of a liner described herein can be integral with top portion 112 of the liner. The fitment can be formed of any suitable material or combination of materials, for example, a suitably rigid plastic such as high density polyethylene (HDPE). In some embodiments, the fitment is more rigid than the rest of the liner. The fitment, in some embodiments, can be securely sealed to the liner via welding or any other suitable method or combination of methods. In some embodiments, where for example the overpack includes a centrally-located mouth or opening, the fitment can also be centrally located on top portion 112 of the liner to minimize stress on the fitment weld; however, central location of the fitment is not required. Some embodiments of the liner of the present disclosure may be configured for use with known overpacks. In such embodiments, the fitment of the liner can be sized and shaped to be compatible with the particular known overpack. Such known overpacks may be compatible, for example, with a fitment having a ¾-inch (1.91-centimeter) or a 2-inch (5.1-centimeter) diameter, for example. It will be understood, however, that a fitment can have any suitable diameter or shape or size that is compatible with a desired overpack.

In use of liner-based packaging to dispense liquids and liquid-based compositions, the liquid or composition is dispensed from the liner by connecting a dispensing assembly including a dip tube or short probe to a port of the liner, with the dip tube being immersed in the contained liquid. Fluid (e.g., gas) pressure is applied to the exterior surface of the liner (i.e., in the space between the liner and a surrounding overpack container), to progressively collapse the liner and thereby force liquid through the dispensing assembly for discharge to associated flow circuitry to flow to an end-use tool or site. Such operation is sometimes referred to as liner-based pressure dispensing.

### Examples

Transportation testing was used to test exemplary liners for formation of through holes. The transportation testing utilized in this work follows the protocols established by the International Safe Transit Association, Procedure 2A (“ISTA 2A”) and the American Society for Testing and Materials Standard F392-93 (reapproved 2004) (“ASTM F392,” also known as “Gelbo flex testing”). ISTA 2A and ASTM F392 are documents, the entire disclosure of which is incorporated by reference herein except for express definitions contained therein.

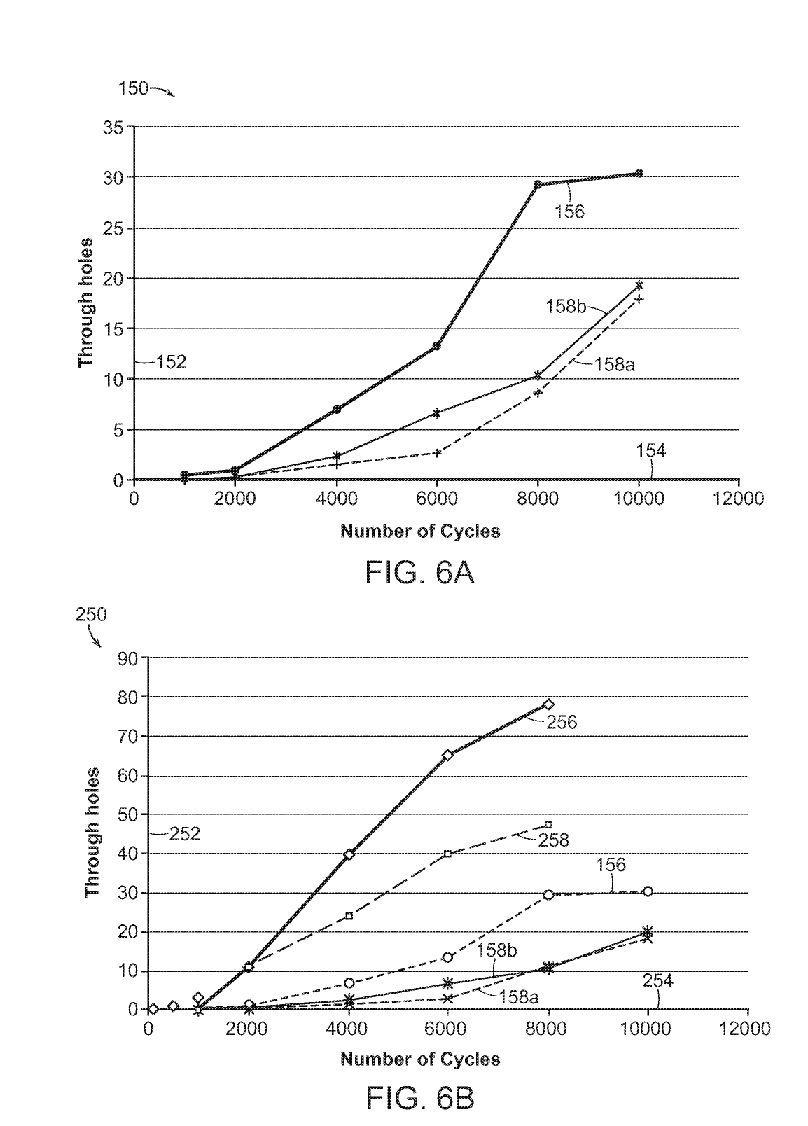

FIG. 6A shows test results 150 comparing polyamide-containing liners of the present disclosure with a liner utilizing a conventional polyamide film. Test results 150 are presented as a graph of the through holes on ordinate 152 versus the number of cycles on abscissa 154. Data set 156 represents the test results from a liner with a conventional film having a 102 μm thickness utilizing a single barrier layer of polyamide, the polyamide layer comprising 8% of the total thickness of the film (8.2 μm for the 102 μm overall thickness). Data sets 158a and 158b both represent test results from a liner utilizing dual barrier layers of polyamide, the dual barriers having a combined thickness that is substantially the same percentage thickness (8%) as the percentage thickness of the polyamide in the single barrier layer film of data set 156. Table 1 discloses the relative thicknesses and identities of layers in the liners used to obtain data sets 158a and 158b. Data set 158a is for a film having 102 μm overall thickness, and data set 158b is for a film having 150 μm overall thickness. The cumulative thickness of polyamide for the film of data set 158a is substantially the same as the single layer thickness of the conventional film of data set 156.

Test results 150 indicate that the dual barrier layers reduce the incidence of through holes by up to a factor of 3 over that of a single barrier layer. For example, at 8000 cycles, data set 156 indicates a through holes count of about 29, whereas the through hole count for data set 158a and 158b are 8 and 11, respectively. This is a surprising result, particularly when comparing data sets 156 and 158a, where the amount of polyamide is the same in each of the compared films.

FIG. 6B shows test results 250 comparing a dual barrier layer and a single barrier layer EVOH-containing liner with liners utilizing films comprising polyamide barrier layer(s). Test results 250 are presented as a graph of the through holes on ordinate 252 versus the number of cycles on abscissa 254. Data set 256 represents the test results from a liner with a conventional film having a total thickness of 100 μm and a single barrier layer of EVOH having a thickness of 10% of the overall total film thickness, or 10 μm. Data set 258 represents test results from a liner utilizing dual barrier layers of EVOH, the dual barriers having a combined thickness that is 8% of the thickness of the liner. Data set 258 is for a film having 100 μm overall thickness. Table 2 discloses the relative thicknesses and identities of layers in the liner used to obtain data set 258. Data sets 156, 158a and 158b are as described above with respect to FIG. 6A.

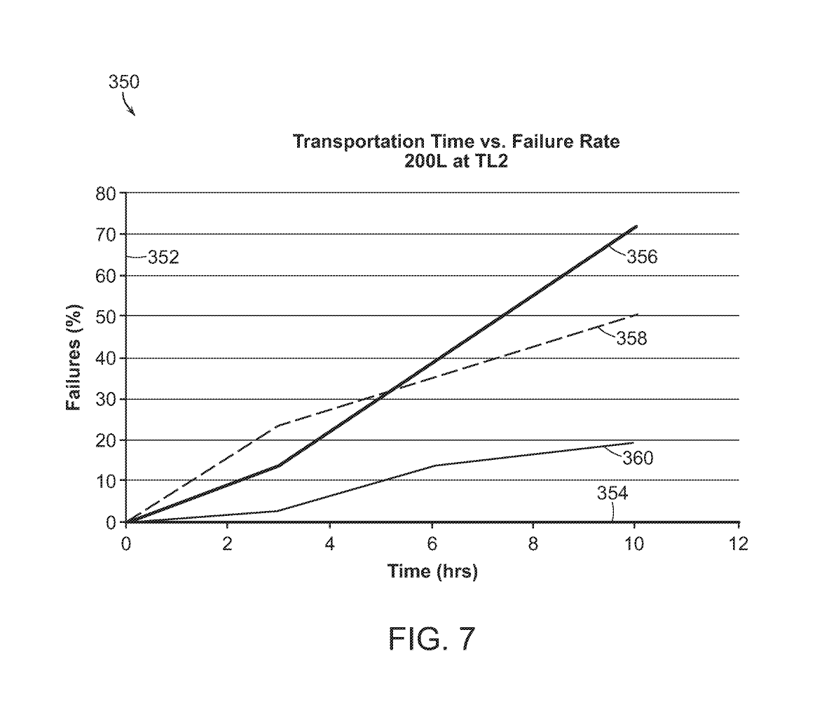

FIG. 7 is a graph comparing the failure rates of various 200 L liners of the present disclosure and 200 L comparative liners as a function of transportation time. Test results 350 are presented as a graph of failure rate on ordinate 352 versus time on abscissa 354. Data set 356 represents the data obtained using a 200-L, 2-D liner made from two plies of a film having a total thickness of 60 μm and a single barrier layer of EVOH having a thickness of 6 μm. Data set 358 represents the data obtained using a 200-L, 3-D liner made from one ply of a film having a total thickness of 100 μm and a single barrier layer of EVOH having a thickness of 10 μm. Data set 360 represents the data obtained using a 200-L 3-D liner made from one play of a film having a total thickness of 125 μm and two barrier layers of polyamide. Table 1 discloses the relative thicknesses and identities of layers in the liner used to obtain data set 360.

FIG. 7 shows that a liner of the present disclosure can be used to reduce failures associated with transportation of liquid over extended periods of time.

Each of the additional figures and methods disclosed herein can be used separately, or in conjunction with other features and methods, to provide improved devices and methods for making and using the same. Therefore, combinations of features and methods disclosed herein may not be necessary to practice the disclosure in its broadest sense and are instead disclosed merely to particularly describe representative and preferred embodiments.

Various modifications to the embodiments may be apparent to one of skill in the art upon reading this disclosure. For example, persons of ordinary skill in the relevant art will recognize that the various features described for the different embodiments can be suitably combined, un-combined, and re-combined with other features, alone, or in different combinations. Likewise, the various features described above should all be regarded as example embodiments, rather than limitations to the scope or spirit of the disclosure.

Persons of ordinary skill in the relevant arts will recognize that various embodiments can comprise fewer features than illustrated in any individual embodiment described above. The embodiments described herein are not meant to be an exhaustive presentation of the ways in which the various features may be combined. Accordingly, the embodiments are not mutually exclusive combinations of features; rather, the claims can comprise a combination of different individual features selected from different individual embodiments, as understood by persons of ordinary skill in the art.

The teachings of all patents, published applications and references cited herein are incorporated by reference in their entirety.

Having thus described several illustrative embodiments of the present disclosure, those of skill in the art will readily appreciate that yet other embodiments may be made and used within the scope of the claims hereto attached. Numerous advantages of the disclosure covered by this document have been set forth in the foregoing description. It will be understood, however, that this disclosure is, in many respects, only illustrative. Changes may be made in details, particularly in matters of shape, size, and arrangement of parts without exceeding the scope of the disclosure. The disclosure's scope is, of course, defined in the language in which the appended claims are expressed.

1. A liner that resists formation of stress-induced breaches, comprising a film formed into a liner capable of retaining a liquid, the film comprising:
a first barrier layer to a gas;
a second barrier layer to the gas; and
at least one additional layer of material disposed interstitially between the first barrier layer and the second barrier layer.

2. A liner that resists formation of stress-induced breaches, comprising a film having an interface, a first innermost layer, a second innermost layer, a first interstitial layer, a second interstitial layer, a first barrier layer, a second barrier layer, a third interstitial layer, a fourth interstitial layer, a first cladding layer and a second cladding layer, wherein:
the first and second innermost layers contact one another to define the interface;
the first interstitial layer is disposed between the first innermost layer and the first barrier layer and the first barrier layer is disposed between the first interstitial layer and the third interstitial layer;
the first cladding layer is disposed on the exterior of the third interstitial layer;
the second interstitial layer is disposed between the second innermost layer and the second barrier layer and the second barrier layer is disposed between the second interstitial layer and the fourth interstitial layer; and
the second cladding layer is disposed on the exterior of the fourth interstitial layer.

3. The liner of claim 1, wherein the first barrier layer and the second barrier layer have a gas permeability for a gas that is the same, and the gas permeability is from about 0.1 to about 10 cc-mil/I00 in²/day for the gas.

4. The liner of claim 3, wherein the first barrier layer and the second barrier layer have a gas permeability of from about 1 to about 10 cc-mil/I00 in²/day for the gas.

5. The liner of claim 3, wherein the first barrier layer and the second barrier layer have a gas permeability of from about 0.1 to about 1 cc-mil/I00 in²/day for the gas.

6. The liner of claim 1, wherein the gas is oxygen.

7. The liner of claim 1, wherein the first barrier layer and the second barrier layer are the same material.

8. The liner of claim 7, wherein the material of the first barrier layer and the second barrier layer comprises polyamide.

9. The liner of claim 7, wherein the material of the first barrier layer and the second barrier layer comprises ethylene vinyl alcohol.

10. The liner of any one of claims 1-9, wherein the film has a thickness of from about 25 μm to about 500 μm.

11. (canceled)

12. (canceled)

13. The liner of claim 1, wherein the first barrier layer and the second barrier layer each have a thickness that is from about 5% to about 10% of the thickness of the film.

14. (canceled)

15. (canceled)

16. The liner of claim 1, wherein the liner is a three-dimensional liner.

17. The liner of claim 1, wherein the liner further comprises a fitment sealed to a portion of the liner.

18. A liner-based system, comprising an overpack and a liner of claim 1.

19. A method of manufacturing a liner that resists formation of stress-induced breaches, comprising:
co-extruding a tubular structure including a wall having a plurality of layers, the wall including an innermost layer of the plurality of layers and a barrier layer surrounding the innermost layer, the barrier layer providing a barrier to a gas;
collapsing the tubular structure so that the innermost layer contacts itself at an interface to define a sheet material having a mirror image of the plurality of layers about the interface, the sheet material providing two innermost layers captured between two barrier layers; and
forming the sheet material into a liner capable of retaining a liquid.

20. The method of claim 19, wherein the tubular structure of the step of co-extruding further comprises at least one interstitial layer between the innermost layer and the barrier layer, such that the sheet material provides two interstitial layers disposed between the two barrier layers after the step of collapsing.

21. The method of claim 19, wherein the innermost layer bonds to itself at the interface after the step of collapsing.

22. The method of claim 19, wherein the liner is a three-dimensional liner.
